(19) United States
(12) Patent Application Publication
(10) Pub. No.: US 2022/0132284 A1
(43) Pub. Date: Apr. 28, 2022

(54) SYSTEM AND METHOD FOR STORING VEHICLE-TO-X SYSTEM DATA IN A HOST VEHICLE EVENT DATA RECORDER

(71) Applicant: Lear Corporation, Southfield, MI (US)

(72) Inventors: Hongen TU, Southfield, MI (US); Jagat GHIMIRE, Southfield, MI (US); Christian BALMACEDA, Southfield, MI (US); David R. MULLIGAN, Livonia, MI (US)

(73) Assignee: Lear Corporation, Southfield, MI (US)

(21) Appl. No.: 17/081,242

(22) Filed: Oct. 27, 2020

(51) Int. Cl. H04W 4/46; B60W 30/08

(52) U.S. Cl. CPC H04W 4/46; B60W 30/08; B60W 2556/65; B60W 2520/00; B60W 2030/082

(57) ABSTRACT

A system and method are described for storing vehicle-to-x system data in a host vehicle. The system includes a communication unit to be mounted in the host vehicle and configured to receive a vehicle-to-x communication including data indicative of a characteristic of a second vehicle. The system may further include a controller to be mounted in the host vehicle and provided in communication with the communication unit. The controller may be configured to store in an associated memory data indicative of a characteristic of the host vehicle and the data indicative of a characteristic of the second vehicle. The controller may be further configured to transfer the data stored in the associated memory to an event data recorder to be mounted in the host vehicle.

### TECHNICAL FIELD

The following relates to a system and method for storing vehicle-to-x (V2X) system data from a V2X communication system in an event data recorder of a host vehicle.

### BACKGROUND

Vehicle-to-everything (V2X) communication is the passing of information from a vehicle to any entity that may affect the vehicle, and vice versa. V2X is a vehicular communication system that incorporates or includes other more specific types of communication such as Vehicle-to-Infrastructure (V2I), Vehicle-to-Network (V2N), Vehicle-to-Vehicle (V2V), Vehicle-to-Pedestrian (V2P), Vehicle-to-Device (V2D), and Vehicle-to-Grid (V2G). The main motivations for V2X communication are road safety, traffic efficiency, and energy savings.

There are two types of V2X communication technology depending on the underlying technology being used. One is Dedicated Short Range Communication (DSRC) Wireless Local Area Network (WLAN) based, and the other is cellular based (which may be referred to as CV2X). V2X communication may use WLAN technology and work directly between vehicles, which form a vehicular ad-hoc network as two V2X transmitters come within each range of each other. Hence it does not require any infrastructure for vehicles to communicate, which is key to assure safety in remote or little developed areas.

WLAN is particularly well-suited for V2X communication, due to its low latency. It transmits and receives messages known as Cooperative Awareness Messages (CAM) and Decentralized Environmental Notification Messages (DENM) or Basic Safety Message (BSM) at regular intervals (e.g., up to 10 times per second). The data volume of these messages is very low. The radio technology is part of the WLAN 802.11 family of standards developed by the Institute of Electrical and Electronics Engineers (IEEE) and known in the United States as Wireless Access in Vehicular Environments (WAVE) and in Europe as ITS-G5.

In an accident involving multiple vehicles, it may be difficult for authorities to determine which driver of the vehicles was at fault. This difficulty can be due to a lack of hard evidence showing which driver may have been operating a vehicle improperly. Such improper operation may include speeding, sudden braking, failure to slow and/or stop at a light or stop sign, executing an illegal turn, failure to yield the right-of-way, etc. Currently, this determination is made based on certain standard rules, accident reconstruction, and eyewitness testimony, which are not necessarily fair or accurate.

Moreover, many hit-and-run vehicle accidents occur in the U.S. and around the globe each year. For such accidents, it can be difficult, if not impossible, to determine the driver or vehicle that left the scene of the accident, since the at-fault driver left the scene without being identified. Investigations of such accidents by authorities could be aided by a mechanism/technology to determine the offender. Further, an awareness by drivers of the existence of such a mechanism/technology could possibly reduce the incidence or number of hit-and-run accident, as such drivers would know that their identification and/or apprehension by authorities would the likely.

An event data recorder (EDR) is a device that records certain information from a vehicle immediately before, during, and/or immediately after most serious crashes. As noted by the U.S. National Highway Transportation Safety Administration (NHTSA), an EDR is any device installed in a motor vehicle to record technical vehicle and occupant information for a brief period of time before, during, and/or after an accident involving the vehicle. (See, e.g., https://www.nhtsa.gov/research-data/event-data-recorder.) Such a device may alternatively be referred to as an accident data recorder, “black box”, crash data recorder, in-vehicle data recorder, or the like. In some instances, an EDR may store information which may be helpful to crash investigators, authorities, or others to determine culpability in the event of an accident. However, such information may be insufficient to make determinations concerning accident culpability. Moreover, due to memory size limitation of an EDR, data logging is a continuous rolling record and, as a result, the data log record of an EDR may be overwritten (erased) after an accident.

A need therefore exists for a system and method for storing V2X system data from a V2X communication system in an EDR of a host vehicle. Such a system and method would help to address, mitigate, solve, and/or eliminate the issues noted above associated with fault determinations, including vehicle and/or driver identification, for vehicle accidents by permanently storing V2X system data associated with the vehicle or vehicles involved.

### SUMMARY

According to one non-limiting exemplary embodiment described herein, a system is provided for storing vehicle-to-x system data in a host vehicle. The system may comprise a communication unit to be mounted in the host vehicle and configured to receive a vehicle-to-x communication comprising data indicative of a characteristic of a second vehicle, and a controller to be mounted in the host vehicle and provided in communication with the communication unit. The controller may be configured to store in an associated memory data indicative of a characteristic of the host vehicle and the data indicative of a characteristic of the second vehicle. The controller may be further configured to transfer the data stored in the associated memory to an event data recorder to be mounted in the host vehicle.

According to another non-limiting exemplary embodiment described herein, a method is provided for storing vehicle-to-x system data in a host vehicle. The method may comprise receiving at the host vehicle a vehicle-to-x communication comprising data indicative of a characteristic of a second vehicle, and storing in a memory to be mounted in the host vehicle data indicative of a characteristic of the host vehicle and the data indicative of a characteristic of the second vehicle. The method may further comprise transferring the data stored in the memory to an event data recorder to be mounted in the host vehicle.

A detailed description of these and other non-limiting exemplary embodiments of a system and method for storing V2X system data from a V2X communication system in an EDR of a host vehicle is set forth below together with the accompanying drawings.

### BRIEF DESCRIPTION OF THE DRAWINGS

FIG. 1 is a block diagram of non-limiting exemplary vehicles equipped with a non-limiting exemplary V2X communication system for use with a system and method for storing V2X system data from a V2X communication system in an EDR of a host vehicle according to one non-limiting exemplary embodiment of the present disclosure; and

FIG. 2 is an illustration of a non-limiting exemplary driving environment which may be associated with a system and method for storing V2X system data from a V2X communication system in an EDR of a host vehicle according to one non-limiting exemplary embodiment of the present disclosure.

### DETAILED DESCRIPTION

As required, detailed non-limiting embodiments are disclosed herein. However, it is to be understood that the disclosed embodiments are merely exemplary and may take various and alternative forms. The figures are not necessarily to scale, and features may be exaggerated or minimized to show details of particular components. Therefore, specific structural and functional details disclosed herein are not to be interpreted as limiting, but merely as a representative basis for teaching one skilled in the art.

With reference to the Figures, a more detailed description of non-limiting exemplary embodiments of a system and method for storing V2X system data from a V2X communication system in an EDR of a host vehicle will be provided. For ease of illustration and to facilitate understanding, like reference numerals may be used herein for like components and features throughout the drawings.

As previously described, vehicle-to-everything (V2X) communication is the passing of information from a vehicle to any entity that may affect the vehicle, and vice versa. V2X is a vehicular communication system that incorporates or includes other more specific types of communication such as Vehicle-to-Infrastructure (V2I), Vehicle-to-Network (V2N), Vehicle-to-Vehicle (V2V), Vehicle-to-Pedestrian (V2P), Vehicle-to-Device (V2D), and Vehicle-to-Grid (V2G). V2X communication is designed to improve road safety, traffic efficiency, and energy savings, and may be implemented using Dedicated Short Range Communication (DSRC) Wireless Local Area Network (WLAN) technology, or alternatively cellular technology. V2X communication may use WLAN technology and work directly between vehicles, which form a vehicular ad-hoc network as two V2X transmitters come within each range of each other. Hence it does not require any infrastructure for vehicles to communicate, which is key to assure safety in remote or little developed areas. WLAN is particularly well-suited for V2X communication, due to its low latency. It transmits messages known as Cooperative Awareness Messages (CAM) and Decentralized Environmental Notification Messages (DENM) or Basic Safety Message (BSM). The data volume of these messages is very low. The radio technology is part of the WLAN 802.11 family of standards developed by the Institute of Electrical and Electronics Engineers (IEEE) and known in the United States as Wireless Access in Vehicular Environments (WAVE) and in Europe as ITS-G5.

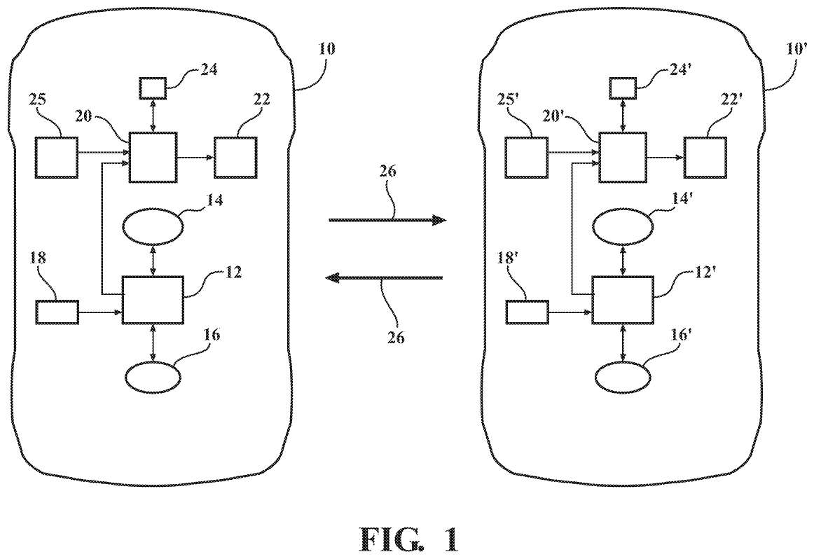

Referring now to FIG. 1, a block diagram of non-limiting exemplary vehicles equipped with a non-limiting exemplary V2X communication system for use with a system and method for storing V2X system data from a V2X communication system in an EDR of a host vehicle according to one non-limiting exemplary embodiment of the present disclosure is shown. As seen therein, a first vehicle 10 may comprise a V2X module 12, a first antenna 14, a second antenna 16, a Global Positioning System (GPS) or other GNSS unit 18, a controller 20, an event data recorder (EDR) 22, a memory 24, and a driver assistance system 25.

The V2X module 12 and the first and second antennas 14, 16 may together be referred to or comprise a vehicle On-Board Unit (OBU). The controller 20 may be provided in communication with the EDR 22, the memory 24, the driver assistance system 25, and the V2X module 12, which itself may be provided in communication with the first and second antennas 14, 16 and the GPS 18. As used herein, the term event data recorder or EDR may be any device installed or to be installed in a motor vehicle to record technical vehicle and/or occupant information for a brief period of time before, during, and/or after an accident involving the vehicle. Such a device may alternatively be referred to as an accident data recorder. “black box”, crash data recorder, in-vehicle data recorder, or the like.

The controller 20 may be configured to store in an associated memory 24 data indicative of a characteristic of the host vehicle 10 and data indicative of a characteristic of the second vehicle 10′, which data indicative of a characteristic of the second vehicle 10′ may be received in a V2X communication 26. The controller 20 may be further configured to transfer the data stored in the associated memory 24 to the EDR 22 to be mounted in the host vehicle 10.

It should be noted that, while shown in FIG. 1 as separate components, the V2X module 12 and the controller 20 may be integrated into a single unit or module, such as the V2X module 12 itself. In that same regard, while the GPS 18 is shown as provided in communication with the V2X module 12, the GPS 18 may alternatively be provided in communication with the controller 20 and/or a unit or module in which the V2X module 12 and controller 20 are integrated, as previously described.

Still referring to FIG. 1, a second vehicle 10′ may similarly comprise a V2X module 12′, a first antenna 14′, a second antenna 16′, a GPS or other GNSS unit 18′, a controller 20′, an EDR 22′, a memory 24′, and a driver assistance system 25′. The V2X module 12′, first and second antennas 14′, 16′, GPS 18′, controller 20′, EDR 22′, memory 24′, and driver assistance system 25′ of the second vehicle 10′ may be provided in communication and configured similarly to the V2X module 12, the first and second antennas 14, 16, the GPS 18, the controller 20, the EDR 22, the memory 24, and the driver assistance system 25 of the first vehicle 10 as described above.

It should be noted that either of the first or second vehicles 10, 10′ may be referred to as a host vehicle. It should also be noted that the description herein of the system and method of the present disclosure in connection with the first and second vehicles 10, 10′ is exemplary only, and that the system and method of the present disclosure may be utilized or implemented with any number of vehicles.

Each of the V2X modules 12, 12′ may be configured to enable and control communication between the first and second vehicles 10, 10′ (i.e., V2V communication) or between the first or second vehicle 10, 10′ and another node or device (e.g., Vehicle-to-Infrastructure (V2I), Vehicle-to-Network (V2N), Vehicle-to-Pedestrian (V2P), Vehicle-to-Device (V2D), or Vehicle-to-Grid (V2G)). Such communication is accomplished utilizing radio frequency signals for transmission of data according to known techniques, protocols, and/or standards associated with such communication. In that regard, the first and/or second antennas 14, 14′, 16, 16′ of the first and second vehicles 10, 10′ may be configured for transmitting and receiving DSRC WLAN or cellular radio frequency signals. Similarly, the GPS or other GNSS units 18, 18′ of the first and second vehicles 10, 10′ may be configured and operate in any known fashion, including providing for wireless GNSS communication.

Each V2X module 12, 12′ and/or V2X module 12, 12′ with antennas 14, 14′, 16, 16′ may also be referred to as a communication unit that may be configured to transmit and receive wireless V2X radio frequency communications 26 as described herein. Similarly, each controller 20, 20′ may include a communication interface or communication unit that may be configured to receive wired communication signals from its respective V2X module 12, 12′ over any vehicle bus, such as a Controller Area Network (CAN) bus.

As those skilled in the art will understand, the V2X modules 12, 12′, antennas 14, 14, 16, 16′, GPS 18, 18′, controllers 20, 20′, EDRs 22, 22′, and/or the driver assistance systems 25, 25′ of the first and second vehicles 10, 10′, as well as any other module, controller, unit, component, system, subsystem, interface, sensor, device, or the like described herein may individually, collectively, or in any combination comprise appropriate circuitry, such as one or more appropriately programmed processors (e.g., one or more microprocessors including central processing units (CPU)) and associated memory, which may include stored operating system software, firmware, and/or application software executable by the processor(s) for controlling operation thereof and for performing the particular algorithm or algorithms represented by the various functions and/or operations described herein, including interaction between and/or cooperation with each other. One or more of such processors, as well as other circuitry and/or hardware, may be included in a single Application-Specific Integrated Circuitry (ASIC), or several processors and various circuitry and/or hardware may be distributed among several separate components, whether individually packaged or assembled into a System-on-a-Chip (SoC). The V2X modules 12, 12′, 12′, antennas 14, 14, 16, 16′, GPS 18, 18′, controllers 20, 20′, the EDRs 22, 22′, and/or the driver assistance systems 25, 25′ may therefore comprise a processor and an associated storage medium having stored computer executable instructions for performing the particular algorithm or algorithms represented by the various functions and/or operations described herein.

As previously noted, all V2X communications 26 include a Basic Safety Message (BSM). As part of each BSM, a DSRC device, such as V2X module 12, 12′ must transmit (i) Longitudinal and latitudinal location within 1.5 meters of the actual position at a Horizontal Dilution of Precision (HDOP) smaller than 5 within the 1 sigma absolute error; and (ii) Elevation location within 3 meters of the actual position at a Horizontal Dilution of Precision (HDOP) smaller than 5 within the 1 sigma absolute error. As part of each BSM, a DSRC device must also transmit speed, heading, acceleration, and yaw rate. Speed must be reported in increments of 0.02 m/s, within 1 km/h (0.28 m/s) of actual vehicle speed. Heading must be reported accurately to within 2 degrees when the vehicle speed is greater than 12.5 m/s (˜28 mph), and to within 3 degrees when the vehicle speed is less than or equal to 12.5 m/s. Additionally, when the vehicle speed is below 1.11 m/s (˜2.5 mph), the DSRC device must latch the current heading and transmit the last heading information prior to the speed dropping below 1.11 m/s. The DSRC device is to unlatch the latched heading when the vehicle speed exceeds 1.39 m/s (˜3.1 mph) and transmit a heading within 3 degrees of its actual heading until the vehicle reaches a speed of 12.5 m/s where the heading must be transmitted at 2 degrees accuracy of its actual heading. Horizontal (longitudinal and latitudinal) acceleration must be reported accurately to 0.3 m/s², and vertical acceleration must be reported accurately to 1 m/s². Yaw rate must be reported accurately to 0.5 degrees/second.

In addition, a Path History data frame will be transmitted as a required BSM element at the operational frequency of the BSM transmission. The Path History data frame requires a history of past vehicles Global Navigation Satellite System (GNSS) locations as dictated by GNSS data elements including Coordinated Universal Time (UTC) time, latitude, longitude, heading, elevation sampled at a periodic time interval of 100 ms and interpolated in-between by circular arcs, to represent the recent movement of the vehicle over a limited period of time or distance. Path History points should be incorporated into the Path History data frame such that the perpendicular distance between any point on the vehicle path and the line connecting two consecutive PH points shall be less than 1 m. The number of Path History points that a vehicle should report is the minimum number of points so that the represented Path History distance (i.e., the distance between the first and last Path History point) is at least 300 m and no more than 310 m, unless initially there is less than 300 m of Path History. If the number of Path History points needed to meet both the error and distance requirements stated above exceeds the maximum allowable number of points (23), the Path History data frame shall be populated with only the 23 most recent points from the computed set of points. A Path History data frame shall be populated with time-ordered Path History points, with the first Path History point being the closest in time to the current UTC time, and older points following in the order in which they were determined.

Path Prediction trajectories will also be transmitted as a required BSM element at the operational frequency of the BSM transmission. Trajectories in a Path Prediction data frame are represented, at a first order of curvature approximation, as a circle with a radius, R, and an origin located at (0,R), where the x-axis is aligned with the perspective of the transmitting vehicle and normal to the vertical axis of the vehicle. The radius, R, will be positive for curvatures to the right when observed from the perspective of the transmitting vehicle, and radii exceeding a maximum value of 32,767 are to be interpreted as a “straight path” prediction by receiving vehicles. When a DSRC device is in steady state conditions over a range from 100 m to 2,500 m in magnitude, the subsystem will populate the Path Prediction data frame with a calculated radius that has less than 2% error from the actual radius. For the purposes of this performance requirement, steady state conditions are defined as those which occur when the vehicle is driving on a curve with a constant radius and where the average of the absolute value of the change of yaw rate over time is smaller than 0.5 deg/s². After a transition from the original constant radius (R1) to the target constant radius (R2), the subsystem shall repopulate the Path Prediction data frame within four seconds under the maximum allowable error bound defined above.

The foregoing and other details concerning V2X communications relating to Federal Motor Vehicle Safety Standards are set forth at 49 CFR (Code of Federal Regulations) Part 571 as well as the Notice of Proposed Rulemaking (NPRM), National Highway Transportation Safety Association Docket No. NHTSA-201600126, which are incorporated herein by reference in their entireties. Also incorporated herein by reference in its entirety is the DSRC standard of the Society of Automotive Engineers, SAE J2945, relating to on-board system requirements for V2V safety communications, including FIGS. 27 and 30 concerning concise and actual path history representation and representation of estimated radius calculations.

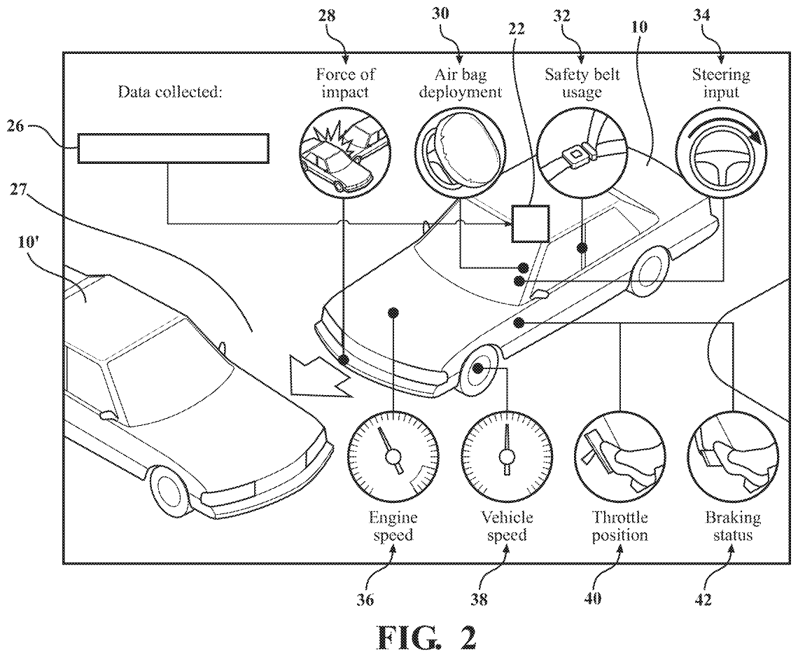

Referring now to FIG. 2, a non-limiting exemplary driving environment is illustrated which may be associated with the system and method for storing V2X system data from a V2X communication system in an EDR of a host vehicle 10 according to one non-limiting exemplary embodiment of the present disclosure. As seen therein, a host vehicle 10 and a second vehicle 10′ are shown in an intersection of a roadway 27 at a moment in time immediately before an accident or collision involving the host vehicle 10 and the second vehicle 10′ will occur, i.e., a time at which a collision involving the host vehicle 10 and the second vehicle 10′ is imminent or impending.

Still referring to FIG. 2, and with continuing reference to FIG. 1 as well, the host vehicle 10 may comprise an EDR 22 mounted at any suitable location therein. As previously described, the EDR 22 may be configured to record certain information associated with the host vehicle 10 for a short period of time immediately before, during, and/or immediately after an accident involving the host vehicle 10. It should be noted that such an accident may be determined or predicted as impending or imminent and indicated to the controller 20 and/or the EDR 22 of the host vehicle 10 as such by the driver assistance system 25. In that regard, the driver assistance system 25 may be of any known type, such as a collision warning system or accident detection system, to be mounted on-board the host vehicle 10 and configured to utilize data and/or information provided by any type of known sensor or sensors (not shown) on-board the host vehicle 10, such as RADAR or LIDAR sensors, impact sensors, accelerometers, or others. It should be noted, however, that any known alternative means or methods may be employed to generate or provide an indication of an accident involving the first vehicle 10, e.g., any type of known sensor or sensors to be mounted on-board the host vehicle 10.

Once again, the EDR 22 of the host vehicle 10 may record data or information immediately before, during, and/or immediately after the accident between the host vehicle 10 and the second vehicle 10′ such as information pertaining to: (i) a force of the impact 28 between the vehicles 10, 10′; (ii) deployment 30 of airbags (e.g., whether and/or when) on-board the host vehicle 10; (iii) usage 32 of safety belts on-board the host vehicle 10 by the driver and/or occupants of the host vehicle 10; (iv) steering input 34 for the host vehicle 10; (v) engine speed 36 of the host vehicle 10; (vi) speed 38 of the host vehicle 10; (vii); throttle position 40 of the host vehicle 10; and (viii) braking status 42 of the host vehicle 10.

In that regard, it should be noted that known systems (not shown) (e.g., airbag system, steering system, engine controller, braking system, etc.) on-board the host vehicle 10 may provide such information to the EDR 22 over a vehicle bus, such as a Controller Area Network (CAN) bus (not shown). It should also be noted that the second vehicle 10′ may also be equipped with an EDR (not shown) which may record similar data associated with the second vehicle 10′ in a manner similar to that described in connection with the EDR 22 of the host vehicle 10 in any known fashion.

As previously described, in an accident involving multiple vehicles (e.g., 10, 10′) such as that illustrated in FIG. 2, it may be difficult for investigators or authorities to determine which driver of the vehicles was at fault due to a lack of hard evidence showing which driver may have been operating a vehicle improperly. Moreover, many hit-and-run vehicle accidents occur each year for which it can be difficult to identify the driver or vehicle that left the scene of the accident. In some instances, an EDR 22 may store information which may be helpful to crash investigators, authorities, or others to determine culpability in the event of an accident. However, such information may be insufficient to make such a determination and, because it is a continuous rolling record, an EDR data log record may be overwritten (erased) after an accident due to EDR memory size limitations.

The present disclosure provides a system and method for storing V2X system data from a V2X communication system in an EDR of a host vehicle that helps to address, mitigate, solve, and/or eliminate the issues noted above associated with fault determinations, including vehicle and/or driver identification, for vehicle accidents by permanently storing V2X system data associated with the vehicle or vehicles involved. In that regard, as previously described, V2X enabled or equipped vehicles send and/or receive V2X communications 26, such as Basic Safety Messages (BSM), at regular intervals. Each BSM 26 may include information such as geo-location of the vehicle, vehicle heading, vehicle model, etc., and a time stamp of the BSM 26. With these BSMs 26 coming from the surrounding vehicles, each vehicle knows its relative location with respect to the surrounding vehicles, which information gets updated every few milliseconds. In current V2X implementations, this constantly changing information, which may be referred to as a “vehicle cluster map” is not saved in permanent memory for future use.

According to the system and method of the present disclosure, such a vehicle cluster map comprising data from BSM or V2X communications 26 may also be saved in the EDR 22 of the host vehicle 10, such as at every new update of such information, which again occurs every few milliseconds. This information may be saved in a permanent electronic memory 24 in the vehicle, such as an Electronically Erasable Programmable Read Only Memory (EEPROM) flash memory, every few minutes and the totality of the information captured in such a fashion during such a time period may be sent to the EDR 22 of the host vehicle 10. In that regard, it should be noted that such a time period may be selected or determined based on system requirements and may be, purely as an example, two to three minutes or three minutes or less. Such captured information may be sent to the EDR 22 when the host vehicle 10 stops or reaches a very low (i.e., threshold) speed after the accident. In that regard, the speed of the host vehicle 10 may be determined by the controller 20 (see FIG. 1) of the host vehicle 10 in any know fashion (e.g., speedometer, accelerometer).

According to the system and method of the present disclosure, the black-box or EDR 22 of the host vehicle 10 involved in an accident with a second vehicle 10′ will contain BSM 26 information about the second vehicle 10′ and any other surrounding vehicle (not shown) at the time at which the accident occurred and the vehicles 10, 10′ were proximate one another. That is, the black box or EDR 22 of the host vehicle 10 will have stored V2X communication 26 information about every vehicle, such as the second vehicle 10′, to which the host vehicle 10 was very close when the accident happened.

With this V2X system data or information 26 permanently stored in the black box or EDR 22 of the host vehicle 10, the trajectory, heading, speed, acceleration, etc., of both vehicles 10, 10′ involved in an accident can be traced for a relevant period of time. Such time stamped information saved over the period of time of a few minutes may help to determine vehicle trajectory immediately before and during an accident. With such a V2X enabled or augmented EDR 22, 22′ installed in vehicles 10, 10′, a trajectory map of both vehicles 10, 10′ can be determined at a time immediately before collision occurred and during the course of the accident. Such information may be helpful to determine whether the drivers of the vehicles 10, 10′ were operating the vehicles 10, 10′ in accordance with the applicable traffic code, rules, or ordinances.

Thus, for non-hit-and-run accidents, the EDR or black-box information (including the V2X data log) of two vehicles involved in an accident may help to determine accurately which driver was at fault. Moreover, for hit-and-run accidents, the EDR or black-box of a vehicle remaining at the scene of the accident can be used to provide important information for the accident investigation, which may be useful to identify a vehicle that left the accident scene by comparing such EDR or black box information of the vehicle remaining at the scene with that of other vehicles.

More specifically, referring now to FIGS. 1 and 2, the present disclosure describes a system for storing V2X system data in a host vehicle 10. The system may comprise a communication unit 12 to be mounted in the host vehicle 10 and configured to receive a V2X communication 26 comprising data indicative of a characteristic of a second vehicle 10′. The system may further comprise a controller 20 to be mounted in the host vehicle 10 and provided in communication with the communication unit 12. The controller 20 may be configured to store in an associated memory 24 data indicative of a characteristic of the host vehicle 10 and the data indicative of a characteristic of the second vehicle 10′. In that regard, the associated memory 24 may comprise a permanent memory to be mounted in the host vehicle. The controller 20 may be further configured to transfer the data stored in the associated memory 24 to an event data recorder 22 to be mounted in the host vehicle 10, which event data recorder 24 may be configured to communicate with the controller 20.

In that regard, the controller 20 may be configured to store in the associated memory 24 data indicative of a characteristic of both the host vehicle 10 and the second vehicle 10′ during a selected period of time. The controller 20 may be configured to transfer such data stored in the associated memory 24 to the event data recorder 22 periodically. Alternatively or additionally, the controller 20 may be configured to transfer such data stored in the associated memory 24 to the event data recorder 22 in response to an indication of an accident involving the host vehicle 10′, or in response to an indication of an accident involving the host vehicle 10′ and a determination that a speed of the host vehicle 10′ fails to exceed a threshold speed.

The controller 20 may be further configured to generate a timestamp associated with the selected period of time, store the timestamp in the associated memory 24, and transfer the timestamp to the event data recorder 22 with the data indicative of a characteristic of the host vehicle 10 and the data indicative of a characteristic of the second vehicle 10′. As previously noted, the selected period of time may be selected or determined based on system requirements and may be, purely as an example, three minutes or less. The controller 20 may alternatively or additionally be configured to transfer the data stored in the associated memory 24 to the event data recorder 22 in response to an update of the data indicative of a characteristic of the host vehicle 10 or an update of the data indicative of a characteristic of the second vehicle 10′, such as upon receipt at the host vehicle 10 of a new or updated BSM 26.

The data indicative of the characteristic of the host vehicle 10 may comprise data indicative of a latitude, longitude, elevation, speed, heading, acceleration, yaw rate, and/or path history of the host vehicle 10. Similarly, the data indicative of the characteristic of the second vehicle 10′ may comprise data indicative of a latitude, longitude, elevation, speed, heading, acceleration, yaw rate, and/or path history of the second vehicle 10′. In that regard, the V2X communication 26 may comprise a BSM and the communication unit 12 to be mounted on the host vehicle 10 may comprise an OBU.

Moreover, the communication unit 12 may be configured to receive a plurality of V2X communications 26, each comprising data indicative of a characteristic of one of a plurality of additional vehicles (not shown)) nearby, proximate to, in the vicinity of, or located in the environment surrounding the host vehicle 10. The controller 20 may be configured to store in the associated memory 24 a vehicle cluster map comprising data indicative of one or more characteristics of each of the plurality of additional vehicles, and may be further configured to transfer such a stored vehicle cluster map to the event data recorder 22.

Referring still to FIGS. 1 and 2, the present disclosure also describes a method for storing V2X system data in a host vehicle 10. The method may comprise receiving at the host vehicle 10 a V2X communication 26 comprising data indicative of a characteristic of a second vehicle 10′, and storing in a memory 24 to be mounted in the host vehicle 20 data indicative of a characteristic of the host vehicle 10 and the data indicative of a characteristic of the second vehicle 10′. The method may further comprises transferring the data stored in the memory 24 to an event data recorder 22 to be mounted in the host vehicle 10.

In that regard, receiving the V2X communication 26 comprising data indicative of a characteristic of a second vehicle 10′ may comprises receiving, at a communication unit 12 to be mounted in the host vehicle 10, the V2X communication 26 comprising data indicative of a characteristic of the second vehicle 10. In that same regard, storing in a memory 24 to be mounted in the host vehicle 10 may comprise storing, by a controller 20 to be mounted in the host vehicle 10, data indicative of a characteristic of the host vehicle 10 and the data indicative of a characteristic of the second vehicle 10′. Similarly, transferring the data stored in the memory 24 may comprise transferring, by the controller 20 to be mounted in the host vehicle 10, the data stored in the memory 24 to an event data recorder 22 to be mounted in the host vehicle 10.

Storing data indicative of a characteristic of the host vehicle 10 may comprise storing data indicative of a characteristic of the host vehicle during a selected period of time. Similarly, storing data indicative of a characteristic of the second vehicle 10′ may comprise storing in the memory data indicative of a characteristic of the second vehicle 10′ during a selected period of time. Transferring data stored in the memory 24 to the event data recorder 22 may comprise transferring data stored in the memory 24 to the event data recorder 22 periodically. Alternatively or additionally, transferring data stored in the memory 24 to the event data recorder 22 may comprise transferring data stored in the memory 24 to the event data recorder 22 in response to an indication of an accident involving the host vehicle 10, or in response to an indication of an accident involving the host vehicle 10′ and a determination that a speed of the host vehicle 10′ fails to exceed a threshold speed.

The method may further comprise generating at the host vehicle 10′ a timestamp associated with the selected period of time, storing the timestamp in the memory 24, and transferring the timestamp to the event data recorder 22 with the data indicative of a characteristic of the host vehicle 10 and the data indicative of a characteristic of the second vehicle 10′. Once again, the selected period of time may be selected or determined based on system requirements and may be, purely as an example, three minutes or less. Moreover, transferring data stored in the memory 24 to the event data recorder 22 may comprise transferring data stored in the memory 24 to the event data recorder 22 in response to an update of the data indicative of a characteristic of the host vehicle 10 or an update of the data indicative of a characteristic of the second vehicle 10′, such as upon receipt at the host vehicle 10 of a new or updated BSM 26.

The data indicative of the characteristic of the host vehicle 10 may again comprise data indicative of a latitude, longitude, elevation, speed, heading, acceleration, yaw rate, and/or path history of the host vehicle 10. Similarly, the data indicative of the characteristic of the second vehicle 10′ may again comprise data indicative of a latitude, longitude, elevation, speed, heading, acceleration, yaw rate, and/or path history of the second vehicle 10′. In that regard, the V2X communication 26 may again comprise BSM.

The method may further comprise receiving at the host vehicle 10 a plurality of V2X communications 26, each comprising data indicative of a characteristic of one of a plurality of additional vehicles (not shown) nearby, proximate to, in the vicinity of, or in the environment surrounding the host vehicle 10. The method may further comprise storing in the memory 24 a vehicle cluster map comprising data indicative of one or more characteristic of each of the plurality of additional vehicles, and transferring the stored vehicle cluster map to the event data recorder 22.

As is readily apparent from the foregoing, various non-limiting embodiments of a system and method for storing V2X system data from a V2X communication system in an EDR of a host vehicle have been described. The system and method of the present disclosure help to address, mitigate, solve, and/or eliminate the issues noted herein associated with fault determinations for vehicular accidents by permanently storing V2X system data associated with the vehicle or vehicles involved.

While various embodiments have been illustrated and described herein, they are exemplary only and it is not intended that these embodiments illustrate and describe all those possible. Instead, the words used herein are words of description rather than limitation, and it is understood that various changes may be made to these embodiments without departing from the spirit and scope of the following claims.

What is claimed is:

1. A system for storing vehicle-to-x system data in a host vehicle, the system comprising:
a communication unit to be mounted in the host vehicle and configured to receive a vehicle-to-x communication comprising data indicative of a characteristic of a second vehicle; and
a controller to be mounted in the host vehicle and provided in communication with the communication unit, wherein the controller is configured to store in an associated memory data indicative of a characteristic of the host vehicle and the data indicative of a characteristic of the second vehicle, and wherein the controller is further configured to transfer the data stored in the associated memory to an event data recorder to be mounted in the host vehicle.

2. The system of claim 1 wherein the controller is configured to store in the associated memory the data indicative of a characteristic of the host vehicle during a selected period of time and the data indicative of a characteristic of the second vehicle during the selected period of time, and wherein the controller is further configured to transfer the data stored in the associated memory to the event data recorder in response to an indication of an accident involving the host vehicle and a determination that a speed of the host vehicle fails to exceed a threshold speed.

3. The system of claim 2 wherein the controller is further configured to generate a timestamp associated with the selected period of time, store the timestamp in the associated memory, and transfer the timestamp to the event data recorder with the data indicative of a characteristic of the host vehicle and the data indicative of a characteristic of the second vehicle.

4. The system of claim 3 wherein the selected period of time is three minutes or less.

5. The system of claim 1 wherein the controller is configured to transfer the data stored in the associated memory to the event data recorder in response to an update of the data indicative of a characteristic of the host vehicle or an update of the data indicative of a characteristic of the second vehicle.

6. The system of claim 1 wherein the controller is configured to transfer the data stored in the associated memory to the event data recorder periodically.

7. The system of claim 1 wherein the data indicative of the characteristic of the host vehicle comprises data indicative of a latitude, longitude, elevation, speed, heading, acceleration, yaw rate, and/or path history of the host vehicle, and wherein the data indicative of the characteristic of the second vehicle comprises data indicative of a latitude, longitude, elevation, speed, heading, acceleration, yaw rate, and/or path history of the second vehicle.

8. The system of claim 7 wherein the communication unit comprises an on-board unit and the vehicle-to-x communication comprises a basic safety message.

9. The system of claim 1 wherein the communication unit is configured to receive a plurality of vehicle-to-x communications, wherein each of the plurality of vehicle-to-x communications comprises data indicative of a characteristic of one of a plurality of additional vehicles, wherein the controller is configured to store in the associated memory a vehicle cluster map comprising the data indicative of a characteristic of each of the plurality of additional vehicles, and wherein the controller is further configured to transfer the stored vehicle cluster map to the event data recorder.

10. The system of claim 1 further comprising:
the associated memory, wherein the associated memory comprises a permanent memory to be mounted in the host vehicle; and
the event data recorder to be mounted in the host vehicle, wherein the event data recorder is configured to communicate with the controller.

11. A method for storing vehicle-to-x system data in a host vehicle, the method comprising:
receiving at the host vehicle a vehicle-to-x communication comprising data indicative of a characteristic of a second vehicle;
storing in a memory to be mounted in the host vehicle data indicative of a characteristic of the host vehicle and the data indicative of a characteristic of the second vehicle; and
transferring the data stored in the memory to an event data recorder to be mounted in the host vehicle.

12. The method of claim 11 wherein:
receiving the vehicle-to-x communication comprising data indicative of a characteristic of a second vehicle comprises receiving, at a communication unit to be mounted in the host vehicle, the vehicle-to-x communication comprising data indicative of a characteristic of the second vehicle;
storing in a memory to be mounted in the host vehicle comprises storing, by a controller to be mounted in the host vehicle, data indicative of a characteristic of the host vehicle and the data indicative of a characteristic of the second vehicle; and
transferring the data stored in the memory comprises transferring, by the controller to be mounted in the host vehicle, the data stored in the memory to an event data recorder to be mounted in the host vehicle.

13. The method of claim 11 wherein:
storing in the memory the data indicative of a characteristic of the host vehicle comprises storing in the memory the data indicative of a characteristic of the host vehicle during a selected period of time;
storing in the memory the data indicative of a characteristic of the second vehicle comprises storing in the memory the data indicative of a characteristic of the second vehicle during the selected period of time; and
transferring the data stored in the memory to the event data recorder comprises transferring the data stored in the memory to the event data recorder in response to an indication of an accident involving the host vehicle and a determination that a speed of the host vehicle fails to exceed a threshold speed.

14. The method of claim 13 further comprising:
generating at the host vehicle a timestamp associated with the selected period of time;
storing the timestamp in the memory; and
transferring the timestamp to the event data recorder with the data indicative of a characteristic of the host vehicle and the data indicative of a characteristic of the second vehicle.

15. The method of claim 14 wherein the selected period of time is three minutes or less.

16. The method of claim 11 wherein transferring the data stored in the memory to the event data recorder comprises transferring the data stored in the memory to the event data recorder in response to an update of the data indicative of a characteristic of the host vehicle or an update of the data indicative of a characteristic of the second vehicle.

17. The method of claim 11 wherein transferring the data stored in the memory to the event data recorder comprises transferring the data stored in the memory to the event data recorder periodically.

18. The method of claim 11 wherein the data indicative of the characteristic of the host vehicle comprises data indicative of a latitude, longitude, elevation, speed, heading, acceleration, yaw rate, and/or path history of the host vehicle, and wherein the data indicative of the characteristic of the second vehicle comprises data indicative of a latitude, longitude, elevation, speed, heading, acceleration, yaw rate, and/or path history of the second vehicle.

19. The method of claim 11 wherein the vehicle-to-x communication comprises a basic safety message.

20. The method of claim 11 further comprising:
receiving at the host vehicle a plurality of vehicle-to-x communications, wherein each of the plurality of vehicle-to-x communications comprises data indicative of a characteristic of one of a plurality of additional vehicles;
storing in the memory a vehicle cluster map comprising the data indicative of a characteristic of each of the plurality of additional vehicles; and
transferring the stored vehicle cluster map to the event data recorder.
